(19) United States
(12) Patent Application Publication
(10) Pub. No.: US 2026/0084272 A1
(43) Pub. Date: Mar. 26, 2026

(54) Hand-Held Power Tool comprising a Tool Holder and a Locking Unit

(71) Applicant: Robert Bosch GmbH, Stuttgart (DE)

(72) Inventors: Tobias Herr, Grafenau (DE); Jens Blum, Filderstadt (DE); Rainer Britz, Schorndorf (DE)

(21) Appl. No.: 19/108,642

(22) PCT Filed: Aug. 4, 2023
(86) PCT No.: PCT/EP2023/071691

§ 371 Date: Mar. 4, 2025

(30) Foreign Application Priority Data
Sep. 7, 2022 (DE) 10 2022 209 287.2

(51) Int. Cl. B25B 23/00; B25F 5/00; B25F 5/02

(52) U.S. Cl. CPC B25B 23/0035; B25F 5/001; B25F 5/02

(57) ABSTRACT

A hand-held power tool has a housing, in which a drive motor and a gear box for driving a tool holder are arranged. The tool holder is provided with a receiving sleeve, and with a locking unit for locking and unlocking an insert tool which can be disposed in the receiving sleeve. The locking unit is associated with at least one locking element pressed by a spring element. The receiving sleeve includes a spring holder for receiving the spring element. The spring holder is disposed at least approximately parallel to an axis of rotation of the tool holder.

### PRIOR ART

The present invention relates to a hand-held power tool having a housing, in which a drive motor and a gear box for driving a tool holder are disposed, wherein the tool holder is provided with a receiving sleeve, and with a locking unit for locking and unlocking an insert tool which can be disposed in the receiving sleeve, wherein the locking unit is associated with at least one locking element pressed by a spring element, and wherein the receiving sleeve comprises a spring holder for receiving the spring element.

Such a hand-held power tool with a locking unit is known from the prior art. This hand-held power tool has a housing in which a drive motor and a gear box for driving a tool holder are disposed. The tool holder is provided with a receiving sleeve. Furthermore, a locking unit is provided for locking and unlocking an insert tool which can be disposed in the receiving sleeve. The locking unit is associated with at least one locking element pressed by a spring element, wherein the receiving sleeve comprising a spring holder for receiving the spring element. The spring holder is arranged perpendicular to an axis of rotation of the tool holder and presses the locking element perpendicular to the tool holder and into the receiving sleeve.

### DISCLOSURE OF THE INVENTION

The invention relates to a hand-held power tool having a housing, in which a drive motor and a gear box for driving a tool holder are disposed, wherein the tool holder is provided with a receiving sleeve, and with a locking unit for locking and unlocking an insert tool which can be disposed in the receiving sleeve, wherein the locking unit is associated with at least one locking element pressed by a spring element, and wherein the receiving sleeve comprises a spring holder for receiving the spring element. The spring holder is arranged at least approximately parallel to an axis of rotation of the tool holder.

The invention thus allows the provision of a hand-held power tool that has a compact locking unit because the spring holder is arranged at least approximately parallel to the axis of rotation of the tool holder.

Preferably, the spring holder is arranged between an interior receptacle of the receiving sleeve and at least one bearing element of the tool holder disposed on the outer circumference of the receptacle.

Thus, a suitable arrangement of the spring holder for forming a compact locking unit can be facilitated in a simple manner.

Preferably, the spring holder is sealed at least in regions along the axis of rotation of the tool holder against the at least one bearing element.

Thus, a safe and reliable arrangement of the spring element which can be disposed in the spring holder can be enabled.

Preferably, the spring holder is oriented at a predetermined angle to the axis of rotation of the tool holder.

Thus, the at least approximately parallel arrangement of the spring holder relative to the axis of rotation of the tool holder can be enabled easily and straightforwardly.

Preferably, the spring holder is arranged in the receiving sleeve substantially transverse to a receptacle of the locking element.

A suitable arrangement of the spring holder relative to the locking element can thus be enabled in a simple manner.

Preferably, the spring element is disposed at least in sections within an inner circumference of the at least one bearing element.

A compact arrangement of the spring element can be provided thereby.

The spring element is preferably disposed at least in sections radially to the axis of rotation of the tool holder between the inner receptacle of the receiving sleeve and the at least one bearing element.

Thus, a compact arrangement of the spring element can be enabled in a simple and uncomplicated manner.

According to one embodiment, a recess for arranging a ring element associated with the spring element is disposed on the outer circumference of the receiving sleeve.

A secure and reliable arrangement of the ring element on the receiving sleeve can thus be enabled.

Preferably, the ring element presses the spring element into the spring holder.

Thus, a simple and robust arrangement of the spring element in the spring mount can be enabled.

According to one embodiment, the locking unit comprises an actuating sleeve for unlocking an insert tool which can be disposed in the tool holder, wherein the actuating sleeve is provided for releasing the locking element pressed by the spring element.

Locking can therefore be enabled in a simple manner.

Preferably, the operating sleeve is movable along a direction leading from the hand-held power tool for unlocking an insert tool disposed in the tool holder.

Thus, a safe and reliable unlocking with a comparatively short travel distance of the operating sleeve can be enabled.

Preferably, in at least one state, the locking element is disposed at least in sections within an inner circumference of the at least one bearing element.

Thus, a stable arrangement of the locking element can be enabled.

The locking element is preferably disposed in at least one state radial to the axis of rotation of the tool holder between the interior receptacle of the receiving sleeve and the at least one bearing element.

Thus, a simple and robust arrangement of the locking element can be enabled.

According to one embodiment, the locking unit is arranged at least in sections radially to the axis of rotation of the tool holder between the interior receptacle of the receiving sleeve and the at least one bearing element.

Thus, a compact design of the locking unit may be enabled in a simple manner.

Preferably, the spring holder is configured such that the at least one bearing element contacts the spring element disposed in the spring holder in sections on its inner circumference facing the tool holder.

Thus, the spring element can be supported in a simple and uncomplicated manner.

### BRIEF DESCRIPTION OF THE DRAWINGS

The invention is explained in more detail in the following description with reference to the exemplary embodiments shown in the drawings. The figures show:

FIG. 1 a schematic view of a hand-held power tool with a tool holder and a locking unit,

FIG. 2 a longitudinal section through the tool holder and the locking unit of FIG. 1 in an unlocking position, as well as a plan view of an insert tool,

FIG. 3 a longitudinal section through the tool holder and the locking unit of FIG. 2 during insertion of the insert tool of FIG. 2 into the tool holder.

FIG. 4 an excerpt of a longitudinal section through the tool holder and the locking unit of FIG. 2 and FIG. 3 during advanced insertion of the insert tool of FIG. 2 into the tool holder,

FIG. 5 an excerpt of a longitudinal section through the tool holder and the locking unit from FIG. 2 to FIG. 4 in a locking position,

FIG. 6 a longitudinal section through the tool holder and the locking unit of FIG. 2 to FIG. 5 when pressing the insert tool out of the tool holder in the locking position, and

FIG. 7 an excerpt of a longitudinal section through the tool holder and the locking unit of FIG. 2 to FIG. 6 during unlocking.

### DESCRIPTION OF THE EXEMPLARY EMBODIMENTS

Elements having the same or a comparable function are provided with the same reference signs in the figures and are described in detail only once.

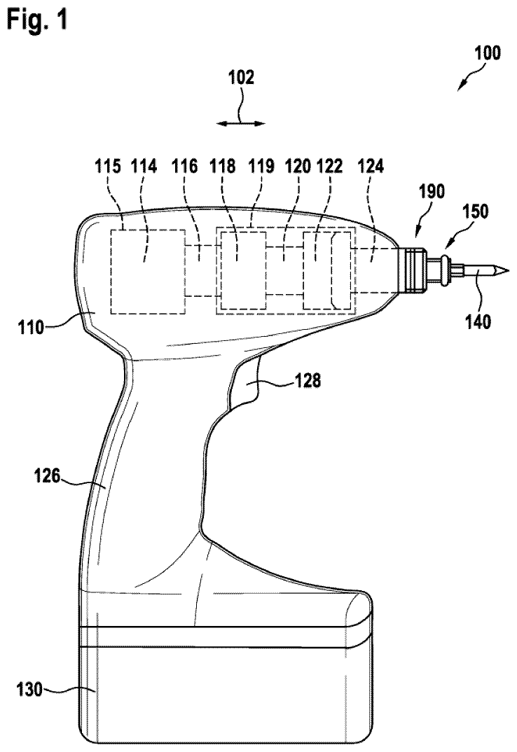

FIG. 1 shows a hand-held power tool 100 with a tool holder 150 which comprises a housing 110 having a handle 126. According to the embodiment shown, the hand-held power tool 100 is mechanically and electrically connectable to a battery pack 130 for electricity supply apart from an electrical network.

Illustratively, a drive motor 114 supplied with electricity by the battery pack 130 and a gear box 118 are arranged within the housing 110. The drive motor 114 is, e.g., operable (i.e., can be switched on and off) via a hand switch 128, and can be any desired type of motor, e.g., an electronically commutated motor or a DC motor. Preferably, the drive motor 114 can be controlled or regulated electronically in such a way that both a reversing operation and specifications with regard to a desired rotational speed can be realized. The functionality and construction of a suitable drive motor are sufficiently known from the prior art, so a detailed description is omitted herein for the purpose of brevity in the description.

The drive motor 114 is connected to the transmission 118 via an associated motor shaft 116, which converts rotation of the motor shaft 116 into rotation of an output shaft 124. This conversion is preferably carried out in such a way that the output shaft 124 rotates relative to the motor shaft 116 with increased torque but reduced rotational speed. The drive motor 114 is illustratively disposed within an engine housing 115. The gear box 118 is disposed within a gear box housing 119. The gear box housing 119 and the motor housing 115 are disposed in the housing 110 as examples.

According to one embodiment, a mechanical striking mechanism 122 is provided. The drive motor 114 is connected to the gear box 118 via an associated motor shaft 116 such that rotation of the motor shaft 116 is converted into rotation of an intermediate shaft 120 provided between the transmission 118 and the striking mechanism 122. The mechanical striking mechanism 122 and/or the gear box 118 are arranged in a common gear housing 119 for illustrative purposes. Alternatively, the mechanical striking mechanism 122 can also be disposed in a separate striking mechanism housing.

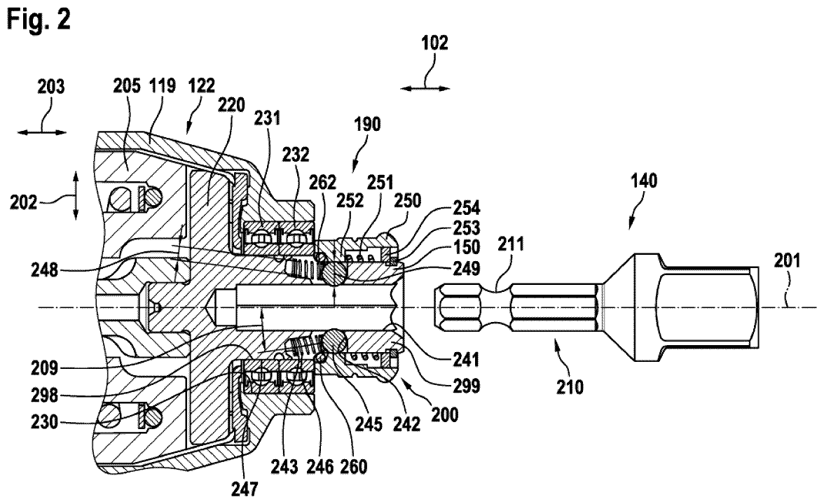

The mechanical striking mechanism 122 connected to the intermediate shaft 120 is, for example, a rotary or oscillating-rotary striking mechanism that generates high-intensity oscillatory rotary impulses and transmits them to an output shaft 124, e.g. an output spindle. In the following, the mechanical striking mechanism is referred to as “mechanical rotary striking mechanism 122”. In particular, the mechanical rotary striking mechanism 122 is provided to drive the tool holder 150. The mechanical rotary striking mechanism 122 comprises a spring-loaded impact body (205 in FIG. 2) that is coupled to the intermediate shaft 120 and is mounted on the intermediate shaft 120 so that it can slide on it in the axial direction 102 of the gear box 118.

Provided on the output shaft 124 is a tool holder 150, which is preferably designed to receive insert tools and is preferably connectable to an insert tool 140 having an outward multi-face coupling. The insert tool 140 is, e.g., designed as a screwdriver bit having an outward multi-face coupling, illustratively an octagonal coupling. Such a screwdriver bit is sufficiently known from the prior art, so a detailed description is omitted herein for the purpose of brevity in the description. Further provided is a locking unit 190 for locking and unlocking the insert tool 140, which is illustratively arranged in the tool holder 150.

FIG. 2 illustrates the tool holder 150 and the locking unit 190 of FIG. 1, wherein the locking unit 190 is illustrated in an unlocking position 200, as well as with the insert tool 140 disposed, by way of example, outside of the tool holder 150. The tool holder 150 illustratively comprises a receiving sleeve 299 in which the insert tool 140 disposed therein can be locked. To this end, the locking unit 190 is associated with at least one locking element 245 pressed by a spring element 246.

Preferably, the receiving sleeve 299 comprises a spring holder 243 for receiving the spring element 246. According to one embodiment, the spring holder 243 is configured as a slot. Preferably, the spring holder 243 is milled.

Preferably, at least one spring element 246 is disposed in at least one spring holder 243. Preferably, there are two diametrically opposed spring holders 243 each having a spring element 246. However, any number of spring holders 243 disposed in the circumferential direction of the receiving sleeve 299 may be provided. According to one embodiment, the at least one or the illustrated two spring elements 246 are configured as compression springs having an inner diameter 248. Preferably, the inner diameter 248 is less than a diameter 249 of the locking element 245. According to one embodiment, the spring element 246 is made of plastic with spring properties.

According to one embodiment, the locking element 245 respectively associated with a spring element 246 is configured as a rotationally symmetrical element, such as a sphere. Alternatively, the locking element 245 may also be configured as a pin.

According to the invention, the spring holder 243 is arranged approximately parallel to an axis of rotation 201 of the tool holder 150. In particular, the spring holder 243 is aligned at a predetermined angle 20l to the axis of rotation 201 of the tool holder 150. The angle 209 is preferably between 0° and 80°, in particular between 5° and 20°. The angle 209 is preferably 12°.

Preferably, the spring holder 243 is disposed radially between an interior holder 241 of the receiving sleeve 299 and at least one bearing element 231, 232 of the tool holder 150 disposed on the outer circumference 247 of the receiving sleeve 299. The spring holder 243 is closed along the axis of rotation 201 of the tool receptacle 150 at least in regions of the at least one bearing element 231, 232. Here, an inner circumference facing the receiving sleeve 299 covers at least one bearing element 232 of the spring holder 243. Preferably, the at least one bearing element 232 on its inner circumference facing the tool holder 150 and the spring element 246 disposed in the spring holder 243 touch in sections. Preferably, the locking unit 190 is disposed at least in sections radially to the axis of rotation 201 of the tool holder 150 between the interior receptacle 241 of the receiving sleeve 299 and the at least one bearing element 231, 232.

Illustratively, two bearing elements 231, 232 are provided, which are disposed in a bearing mount 230 of the housing 110. Preferably, the bearing mount 230 is disposed in the gear box 119 or a striking mechanism housing of the optional mechanically rotary striking mechanism 122. Preferably, the two bearing elements 231, 232 abut one another along a longitudinal extension 203 of the tool holder 150. Preferably, the two bearing elements 231, 232 are configured as roller bearings, in particular ball bearings. It is noted that only one bearing element 231, 232 may also be provided.

Preferably, the spring holder 243 is disposed in the receiving sleeve 299 substantially transverse to a receptacle 242 of the locking element 245. Furthermore, the spring element 246 is preferably disposed at least in sections within an inner circumference 298 of the at least one bearing element 231, 232. Likewise, the spring element 246 is preferably disposed at least in sections radially to the axis of rotation 201 of the tool holder 150 between the interior receptacle 241 of the receiving sleeve 299 and the at least one bearing element 231, 232.

Furthermore, the locking unit 190 illustratively comprises an actuating sleeve 250 for unlocking the insert tool 140 which can be disposed in the tool holder 150, wherein the actuating sleeve 250 is provided for releasing the locking element 245 pressed by the spring element 246. Preferably, the operating sleeve 250 has a pressing section 252 on its inner circumference facing the inner receptacle 241.

In the unlocking position 200 shown in FIG. 2, the locking element 245 partially abuts the pressing section 252. Moreover, the operating sleeve 250 is fixed to an outer circumference 247 of the receiving sleeve 299 via a disc-shaped fixing element 254. The disc-shaped fixing element 254 is preferably associated with a retaining ring 253. The retaining ring 253 is arranged in a circumferential groove formed on the outer circumference 247 of the receiving sleeve 299. A spring element 251 is preferably disposed axially between the pressing section 252 and the disk-shaped fixing element 254. The spring element 251 is configured to press the operating sleeve 250 along the longitudinal extension 203 of the tool holder 150 towards the at least one bearing element 231, 232.

Moreover, a recess 262 for disposing a ring element 260 associated with the spring element 246 is preferably arranged on the outer circumference 247 of the receiving sleeve 299. Preferably, the ring element 260 presses the spring element 246 into the spring holder 243. Here, the ring element 260 prevents the spring element from radially pushing out 246 towards the operating sleeve 250 upon compression of the spring element 246.

Furthermore, preferably, the ring element 260 is configured as an axial stop of the operating sleeve 250 and the application element 252 of the operating sleeve 250, respectively. Furthermore, the ring element 260 is preferably configured as a visual and dirt shield, thereby preventing dirt from entering the locking unit 190. According to one embodiment, the ring element 260 is configured as an O-ring or snap ring.

Preferably, the spring holder 243 and/or the receptacle 242 of the locking element 245 are configured as a type of cylinder or truncated cone. Preferably, the tool holder 150 comprises the at least one spring element 246 associated with the locking element 245 and at least one spring element 251 associated with the operating sleeve 250.

It is noted that in the context of the present invention, the term “radial” is understood to mean a direction approximately perpendicular to the longitudinal extension 203 of the tool holder 150. Further, the term “axial” is understood to mean a direction along or parallel to the longitudinal extension 203 of the tool holder 150. The radial direction 202 is therefore oriented approximately perpendicular to the axial direction 102 of the gear box 118, or rather along the longitudinal extension 203 of the tool holder 150. Further, the axial direction 102 is oriented substantially parallel to the longitudinal extension 203 of the tool holder 150, or rather parallel to an axis of rotation 201 of the tool holder 150.

In accordance with an embodiment of the hand-held power tool 100 with the mechanical rotary striking mechanism 122 of FIG. 1, the mechanical rotary striking mechanism 122 comprises an impact body 205 and an anvil 220 that can be impacted by the impact body 205. The anvil 220 is preferably associated with the tool holder 150. In particular, the anvil 220 is preferably formed integrally with the tool holder 150. The mechanical rotary striking mechanism 122 generates high-intensity rotary pulses and transmits them to the output shaft 124, or via the anvil 220 to the receiving sleeve 299. The spring-loaded impact body 205 is slidably supported in the axial direction 102 of the gear box 118. A mechanical rotary striking mechanism 122 of this kind is sufficiently known from the prior art, so a detailed description is omitted herein for the purpose of brevity in the description.

Furthermore, FIG. 2 illustrates the insert tool 140 being illustratively formed as a bit tool. Preferably, the insert tool 140 comprises a locking area 210. As described in FIG. 1, the locking area 210 comprises an outer multi-face. To lock with the at least one locking element 245, the locking area 210 comprises a locking groove 211 on its outer circumference.

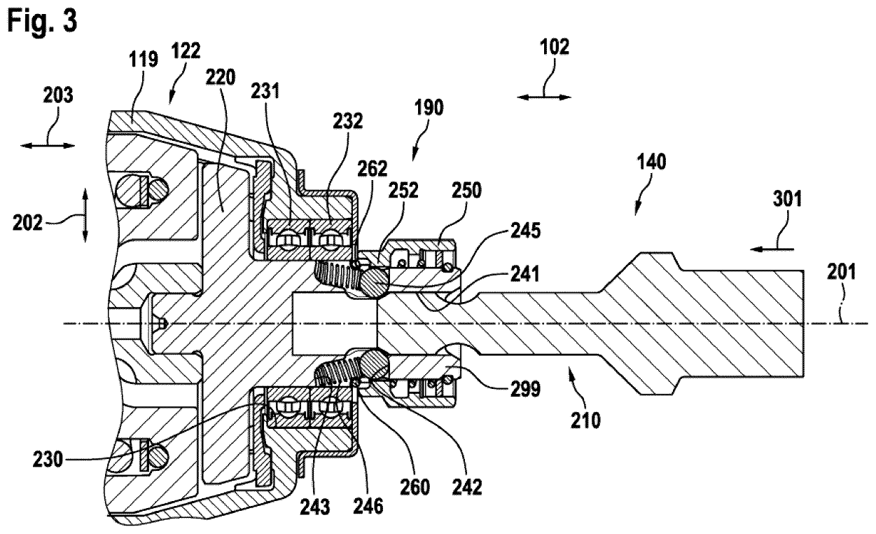

FIG. 3 illustrates the tool holder 150 and the locking unit 190 of FIG. 1 and FIG. 2 upon insertion of the insert tool 140 along an arrow 301 into the interior receptacle 241 of the tool holder 150. Illustratively, the locking area 210 is disposed in sections in the inner receptacle 241 of the receiving sleeve 299. The locking elements 245, which are arranged diametrically opposite to one another, are still not pressed in FIG. 3.

In such an insertion, only the insert tool 140 is inserted into the inner receptacle 241. The operating sleeve 250 need not be actuated by an operator of the hand-held power tool 100 of FIG. 1 in a predetermined direction.

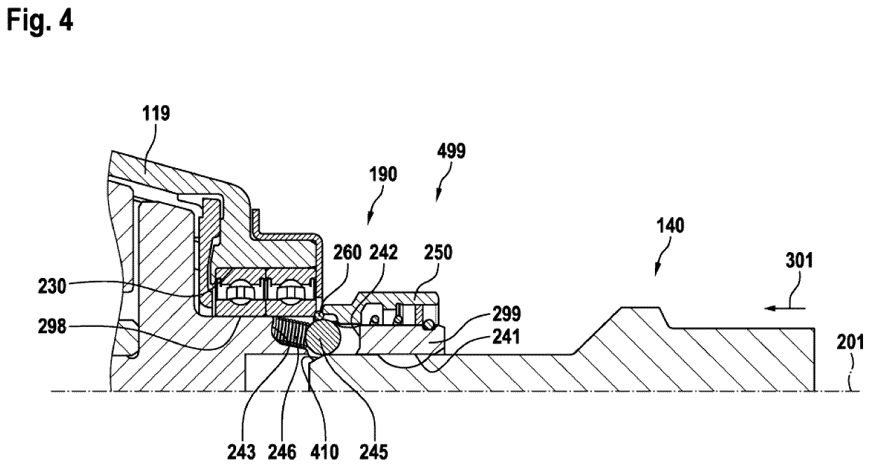

FIG. 4 shows tool holder 150 and the locking unit 190 of FIG. 2 and FIG. 3 in a position 499, with insertion of the insert tool 140 in the direction of the arrow 301 into the interior receptacle 241 of the tool holder 150 being more advanced as compared to FIG. 2. In this case, the locking area 210, or an edge 410 of the insert tool 140, associated with a face of the locking area 210, presses the locking elements 245 disposed diametrically opposed to one another out of the inner receptacle 241 towards the outer circumference 247 of the receiving sleeve 299. The locking elements 245 are pressed against the spring elements 246 in opposition to a spring force of the spring elements 246. The operating sleeve 250 remains substantially stationary.

In the position 499 shown in FIG. 4, the locking element 245 shown is disposed on an inner circumference of the ring element 260 facing the locking element 245. Furthermore, the locking element 245 is disposed at least in sections within the inner circumference 298 of the at least one bearing element 231, 232. In addition, the locking element 245 is preferably disposed radially to the axis of rotation 201 of the tool holder 150 between the inner receptacle 241 of the receiving sleeve 299 and the at least one bearing element 231, 232.

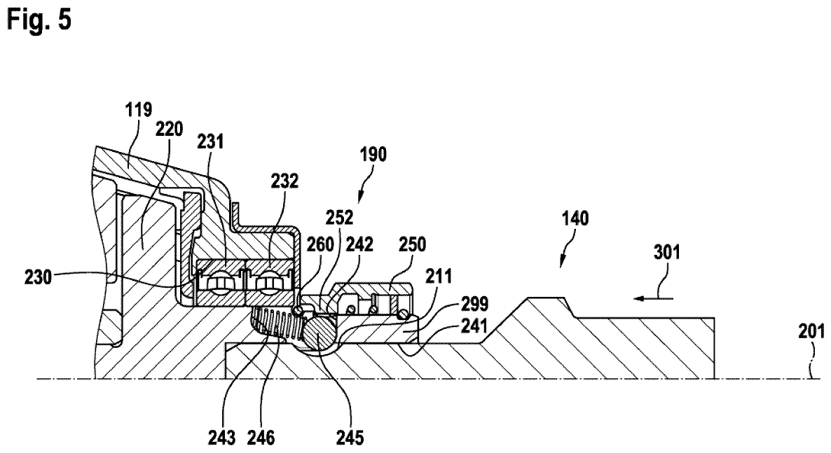

FIG. 5 shows the tool holder 150 and the locking unit 190 of FIG. 2 through FIG. 4 in a locking position 500. In the locking position 500, the insert tool 140 has been moved in the direction of the arrow 301 into the interior receptacle 241 as compared to FIG. 2 through FIG. 4, such that the locking section 210 is disposed in the interior receptacle 241. In so doing, the locking element 245 locks the insert tool 140 to the locking groove 211 in the interior receptacle 241 of the tool holder 150. The locking element 245 is thereby pressed against its receptacle 242 by the spring element 246. At the same time, the pressing section 252 of the operating sleeve 250 presses the locking element 245 into the locking groove 210 of the insert tool 140. The locking element 245 is disposed radially between the insert tool 140 and the pressing section 252. Here, the locking element 245 is preferably disposed axially adjacent the at least one bearing element 231, 232.

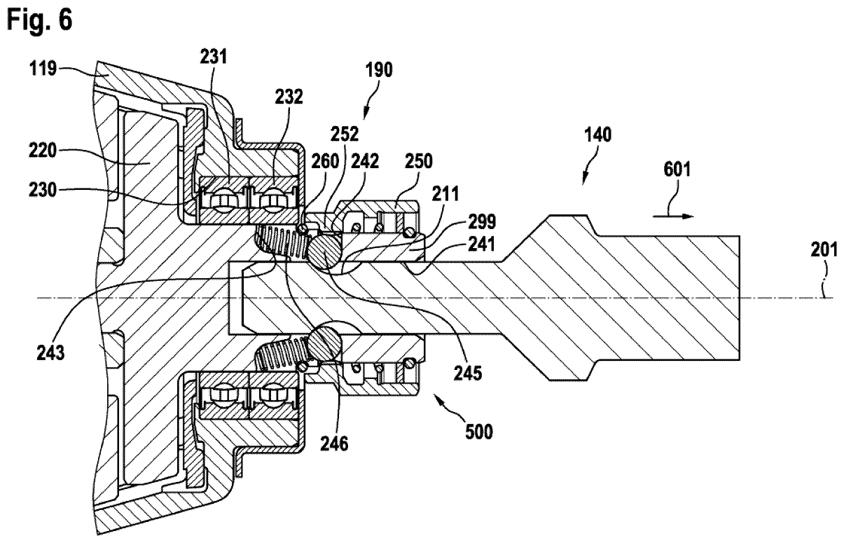

FIG. 6 illustrates tool holder 150 and locking unit 190 of FIG. 2 through FIG. 5 in locking position 500, wherein an axial force 601 presses the insert tool 140 out of the interior receptacle 241. For example, the axial force 601 symbolizes a pull on the insert tool 140. Here, the pressing section 252 presses the locking element 245 against the locking groove 211 of the insert tool 140, thereby locking it in the interior receptacle 241.

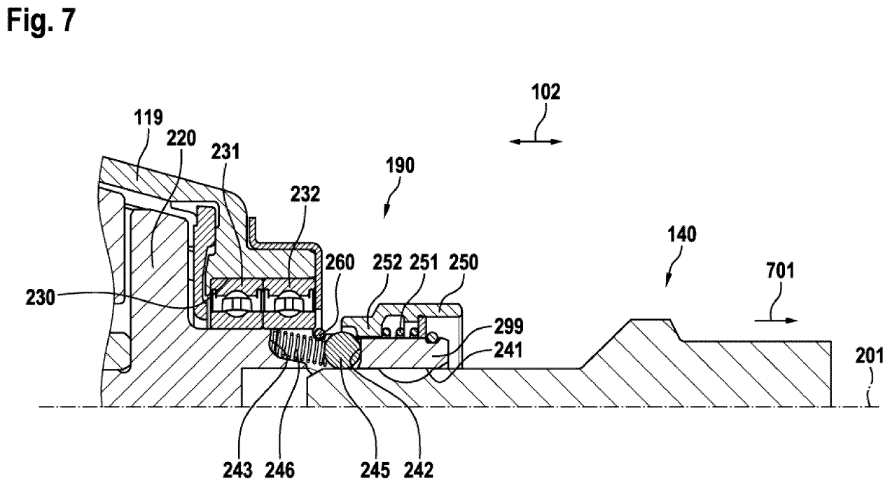

FIG. 7 shows the tool holder 150 and the locking unit 190 of FIG. 2 to FIG. 5 upon unlocking of the insert tool 140. To unlock the tool, the operating sleeve 250 is actively moved axially by a user of the hand-held power tool 100 of FIG. 1 in the direction of an arrow 701 away from the hand-held power tool 100 of FIG. 1, and in so doing, the insert tool 140 is also moved out of the tool holder 150 in the direction of the arrow 701. Here, the spring element 251 of the operating sleeve 250 is compressed, thereby releasing the pressing section 252 of the locking element 245. As a result, preferably, the locking element 245 moves along its receptacle 242 from the interior receptacle 241 approximately radially outward, thereby ultimately disposing the locking element 245 axially adjacent the pressing section 252. In particular, the locking element 245 is disposed in sections in the axial direction 102 between the ring element 260 and the pressing section 252.

1. A hand-held power tool, comprising:
a tool holder;
a drive motor and a gear box configured to drive the tool holder; and
a housing in which the drive motor and the gear box are disposed,
wherein the tool holder is provided with (i) a receiving sleeve, and (ii) a locking unit configured to lock and unlock an insert tool in the receiving sleeve,
wherein the locking unit is associated with at least one locking element pressed by a spring element,
wherein the receiving sleeve comprises a spring holder configured to receive the spring element, and
wherein the spring holder is disposed at least approximately parallel to an axis of rotation of the tool holder.

2. The hand-held power tool of claim 1, wherein the spring holder is disposed between an interior receptacle of the receiving sleeve and at least one bearing element of the tool holder disposed on the outer circumference of the receiving sleeve.

3. The hand-held power tool of claim 2, wherein the spring holder is closed at least in regions against the at least one bearing element along the axis of rotation of the tool holder.

4. The hand-held power tool of claim 1, wherein the spring holder is aligned at a predetermined angle in relation to the axis of rotation of the tool holder.

5. The hand-held power tool of claim 1, wherein the spring holder is disposed in the receiving sleeve substantially transverse to a receptacle of the locking element.

6. The hand-held power tool of claim 1, wherein the spring element is disposed at least in sections within an inner circumference of the at least one bearing element.

7. The hand-held power tool of claim 1, wherein the spring element is disposed at least in sections radially to the axis of rotation of the tool holder between the internal receptacle of the receiving sleeve and the at least one bearing element.

8. The hand-held power tool according to claim 1, wherein a recess for disposing a ring element associated with the spring element is arranged on the outer circumference of the receiving sleeve.

9. The hand-held power tool of claim 8, wherein the ring element is configured and arranged to press the spring element into the spring holder.

10. The hand-held power tool of claim 1, wherein:
the locking unit comprises an actuating sleeve configured to unlock the insert tool disposed in the tool holder, and
the actuating sleeve is configured and arranged to release the locking element pressed by the spring element.

11. The hand-held power tool of claim 9, wherein the operating sleeve is movable along a direction pointing away from the hand-held power tool to unlock an insert tool disposed in the tool holder.

12. The hand-held power tool of claim 2, wherein the locking element is disposed at least in sections within an inner circumference of the at least one bearing element in at least one state.

13. The hand-held power tool of claim 2, wherein the locking element is disposed in at least one state radially to the axis of rotation of the tool holder between the interior receptacle of the receiving sleeve and the at least one bearing element.

14. The hand-held power tool according to claim 2, wherein the locking unit is disposed at least in sections radially to the axis of rotation of the tool holder between the internal receptacle of the receiving sleeve and the at least one bearing element.

15. The hand-held power tool of claim 2, wherein the spring holder is configured and arranged such that the at least one bearing element on its inner circumference facing the tool holder touches the spring element disposed in the spring holder at least in sections.
